(19) United States
(12) Patent Application Publication
(10) Pub. No.: US 2023/0010242 A1
(43) Pub. Date: Jan. 12, 2023

(54) FOLDABLE STEP STOOL WITH FOLD-BLOCKING LOCK

(71) Applicant: Dorel Home Furnishings, Inc., Wright City, MO (US)

(72) Inventors: Kyle J. Lawrence, Greenfield, IN (US); Rudy Xu, Wright City, MO (US)

(21) Appl. No.: 17/856,908

(22) Filed: Jul. 1, 2022

Related U.S. Application Data
(60) Provisional application No. 63/219,158, filed on Jul. 7, 2021.
(60) Provisional application No. 63/292,097, filed on Dec. 21, 2021.

(51) Int. Cl. E06C 1/393; E06C 1/387

(52) U.S. Cl. CPC E06C 1/393; E06C 1/387

(57) ABSTRACT

A foldable step stool includes an expandable step frame, steps pivotably coupled to the expandable step frame, and a fold-blocking lock coupled to one of the steps. The fold-blocking lock is operable to block pivotable movement of the steps relative to the expandable step frame when once foldable step stool has been opened.

### PRIORITY CLAIM

This application claims priority under 35 U.S.C. § 119(e) to two U.S. Provisional Applications Ser. No. 63/219,158, filed Jul. 7, 2021, and Ser. No. 63/292,097, filed Dec. 21, 2021, which are both expressly incorporated by reference herein.

### BACKGROUND

The present disclosure relates to a foldable step stool, and particularly to a step stool including a frame having front and rear legs that move relative to one another during opening and closing of the step stool. More particularly, the present disclosure relates to a foldable step stool having a lock for locking the frame to one of the steps that are pivotably mounted on the frame once the foldable step stool has been opened.

### SUMMARY

A foldable step stool in accordance with the present disclosure includes an expandable step frame, steps pivotably coupled to the expandable step frame, and a fold-blocking lock coupled to one of the steps. The fold-blocking lock is operable to block pivotable movement of the steps relative to the expandable step frame when once foldable step stool has been opened.

In illustrative embodiments, the fold-blocking lock is a step-retainer lock that is coupled to the underside of a metal top step that is pivotably coupled to the expandable step frame. The step-retainer lock includes a latch base and a pivotable crossbar latch supported for pivotable movement about a latch-pivot axis relative to the latch base to engage a step-support crossbar included in the expandable step frame to hold the metal top step in a stationary horizontal position relative to the step frame and stabilize the step frame when the step frame is changed in the field by a stop-stool user from COLLAPSED-STORAGE mode to an EXPANDED-USE mode as the foldable step-stool is opened.

In illustrative embodiments, the step-retainer lock further includes latch-mount means for coupling the latch base to an underside of the metal top step to cause the step-retainer lock to move with the metal top step relative to the step frame during a change of the step frame between the COLLAPSED-STORAGE mode and the EXPANDED-USE mode without forming holes or other blemishes in a step panel of the metal top step. The metal top step includes a step panel on which a user may stand when the step frame is in the EXPANDED-USE mode and a rim coupled to a perimeter of the step panel.

In one illustrative embodiment, the latch base is made of a plastics material and the latch-mount means includes a latch-base anchor made of a metal material. The latch-base anchor is arranged to engage an underside of the step panel of the metal top step and welded to the rim of the metal top step. The latch-base anchor is a strip of metal that lies on the underside of the step panel and is welded at a first end thereof to a first rim side wall of the rim and at a second end thereof to a second rim side wall of the rim. The latch-mount means includes the weldment used to couple the ends of the metal anchor strip to the rim side walls. The latch base is coupled to the metal anchor strip to hold the latch base in a stationary position on an underside of the metal top step to move therewith during opening and closing of the step stool.

In another illustrative embodiment, the latch base is made of a metal material and includes a foundation that is arranged to engage the underside of the metal top step. The foundation of the latch base includes a top wall that engages the underside of the step panel. The rim of the metal top step includes a rim includes a rim front wall that is arranged to extend between and interconnect the first and second rim side walls. The foundation of the latch base also includes a front wall that that engages the rim front wall. The front and top walls of the foundation are perpendicular to one another. The latch-mount means comprises weldment that is coupled to each of the front wall of the foundation and the rim front wall of the rim to hold the latch base in a stationary position on the underside of the metal top step to move therewith during opening and closing of the step stool.

### BRIEF DESCRIPTIONS OF THE DRAWINGS

The detailed description particularly refers to the accompanying figures in which:

FIG. 1 is a front perspective view of a foldable step stool in accordance with the present disclosure showing a step stool including a metal top step, a relatively smaller bottom step, and an expandable step frame configured to support the metal top step and bottom step during a change in the frame from a COLLAPSED-STORAGE mode shown in FIGS. 1 and 2 to an EXPANDED-USE mode shown in FIG. 3, the frame including a front leg unit pivotably coupled to a rear leg unit, and further showing a topside of the metal top step free of fastener-receiver holes or other blemishes;

FIG. 2 is a rear perspective view of the foldable step stool of FIG. 1 showing a step-support crossbar included in the frame and arranged to interconnect upwardly extending first and second legs of the rear frame unit to cause the step-support crossbar to lie in spaced-apart parallel relation to a handgrip included in the front leg unit and also showing a releasable step-retainer lock mounted in a stationary position on an underside of the metal top step and arranged to lie unlocked in separated relation to the step-support crossbar when the frame is in the COLLAPSED-STORAGE mode as shown in FIG. 2 and to lie locked in engaged relation to the step-support crossbar when the frame is expanded to assume the EXPANDED-USE mode as suggested in FIGS. 3, 5A1, and 7 so that the metal top step is retained in a stationary and stable position relative to the step-support crossbar of the frame;

FIG. 3 is a front perspective view of the foldable step stool of FIG. 1 showing the unfolded step stool when the frame is in the EXPANDED-USE mode and suggesting that the releasable step-retainer lock is locked in engagement with the step-support crossbar to stabilize the expanded frame once the step stool is opened;

FIG. 4 is an enlarged view of a circled region in FIG. 2 showing that the step-retainer lock includes a pivotable crossbar latch, a latch base made illustratively of a plastics material, and a latch-base mount that provides means for mounting the plastic latch base on the underside of the metal top step without creating any fastener-receiver holes or other blemishes in a step panel included in a topside of the metal top step as suggested in FIG. 1;

FIG. 4A is another view of the circled region of FIG. 4 suggesting that the latch-base mount of the step-retainer lock is mounted on the underside of the metal top step and that the latch-base mount includes a latch-base anchor that is arranged to extend along an underside of the step panel and is welded at opposite ends to spaced apart side walls of a rim included in the metal top step and also suggesting that the latch-base mount includes base fasteners that are configured to couple the plastic latch base to the stationary welded latch-base anchor as illustrated in FIGS. 6 and 7, and showing that each of the first and second rim side walls of the metal top step is formed to include a cross bar-receiving notch that is sized to accept the step-support crossbar of the frame therein when the frame is in the EXPANDED-USE mode as shown in FIG. 14;

FIG. 5A is an enlarged perspective view of a portion of the releasable step-retainer lock illustrated in FIG. 4 when the frame of the step stool is in the COLLAPSED-STORAGE mode and showing that the pivotable crossbar latch is mounted on a latch-pivot axle that is coupled to the plastic latch base for pivotable movement about a latch-pivot axis and also showing a latch pivoter that is included in the step-retainer lock and associated with the latch-pivot axle for yieldably pivoting the pivotable crossbar latch about the latch-pivot axis in a counterclockwise direction to assume a NORMAL READY position in engagement with one of the latch-pivot blockers included in the plastic latch base and shown in FIG. 5C;

FIG. 5B is a view similar to FIG. 5A showing the pivotable crossbar latch after it has been pivoted by a step-stool user as suggested in FIG. 16 about the latch-pivot axis in a clockwise direction away from the latch-pivot blocker to assume a TEMPORARY RETRACTED position to load the latch pivoter so that the latch can be disengaged from the crossbar as suggested in FIGS. 15 and 16 during a change of the frame of the step stool from the EXPANDED-USE mode to the COLLAPSED-STORAGE mode as suggested in FIGS. 14-16, and further showing a foundation of the latch base that is made of a plastics material and formed to include two fastener-receiver holes for receiving base fasteners as suggested in FIG. 6 to allow the plastic latch base to be coupled to the companion metal latch-base anchor without forming any fastener-receiver holes or other blemishes in the metal top step;

FIG. 5A1 is a sectional view taken along line 5A1-5A1 of FIG. 5A showing the engagement of a second of two fingergrip-support arms included in the pivotable crossbar latch as suggested in FIG. 6 with a second of two latch-pivot blockers included in the latch base as also suggested in FIG. 6 when the frame of the foldable step stool is in the COLLAPSED-STORAGE mode ensuring that the pivotable crossbar latch does not over rotate about the latch-pivot axis in a counterclockwise direction and thus remains in the NORMAL READY position when the frame is in the COLLAPSED-STORAGE mode so that a cam ramp formed on the crossbar is oriented properly to engage and cam on and over the crossbar as the step stool is opened as is apparent from the opening sequence illustrated in FIGS. 10-14;

FIG. 5B1 is a sectional view taken along line 5B1-5B1 of FIG. 5B showing the separation of the second fingergrip-support arm from the underlying second latch-pivot blocker of the latch base as a result of separation of the releasable step-retainer lock from the step-support crossbar and movement of the releasable step-retainer lock to assume the TEMPORARY RETRACTED position during closing of the step stool as suggested in FIGS. 15 and 16;

FIG. 5C is an exploded perspective assembly view of the releasable step-retainer lock shown in FIGS. 5A and 5B showing that the releasable step-retainer lock comprises a pivotable crossbar latch, a latch pivoter including first and second latch-pivoting (torsion) springs, a latch-pivot axle, and a latch base including a foundation formed to include a latch-base anchor receiver channel and two fastener-receiver holes, first and second axle-support bearings adapted to receive the latch-pivot axle therein, and first and second latch-pivot blockers, and also showing that the pivotable crossbar latch includes a fingergrip providing the crossbar cam ramp and a pair of fingergrip-support arms providing two axle-mount bearings for receiving the latch-pivot axle therein;

FIG. 6 is an exploded bottom perspective assembly view of the step stool of FIG. 2 suggesting that the metal latch-base anchor of the latch-base mount can be moved to engage the underside of the metal top step so that the metal latch-base anchor can be welded to the metal top step and that first and second base fasteners of the latch-base mount can be passed through companion fastener-receiver holes formed in the foundation of the plastic latch base and the metal latch-base anchor to couple the releasable step-retainer lock to the latch-base anchor after the latch-base anchor has been welded to the metal top step as suggested in FIG. 7 without forming any fastener-receiver holes or other blemishes in the metal top step;

FIG. 7 is an unexploded bottom perspective view of the foldable step stool of FIG. 6 with most of the step-support crossbar of the frame broken away showing the frame of the step stool in the EXPANDED-USE mode and the metal latch-base anchor of the latch-base mount welded to the underside of the metal top step and mated to the plastic latch base to hold the releasable step-retainer lock in a fixed NORMAL READY position on the metal top step;

FIG. 8 is an enlarged perspective view of the releasable step-retainer lock of the step stool showing that the plastic latch base of the releasable step-retainer lock is mounted using base fasteners on the metal latch-base anchor of the latch mount that has been welded in place on the underside of the metal top step and suggesting that the first and second latch-pivoting (torsion) springs of the latch pivoter are biased to rotate the pivotable crossbar latch normally in a counterclockwise direction about a latch-pivot axis to engage the first and second latch-pivot blockers of the latch base so that further counterclockwise rotation of the pivotable crossbar latch is blocked to establish the NORMAL READY position of the pivotable crossbar latch;

FIG. 9 is an enlarged perspective view of a releasable step-retainer lock in accordance with another embodiment of the present disclosure in which the pivotable crossbar latch includes a finger grip provided with two finger-receiver grooves instead of the four finger-receiver grooves shown in the embodiment of FIGS. 1-8;

FIGS. 10-14 show a step-stool-opening sequence in which the frame is changed from the COLLAPSED-STORAGE mode shown in FIGS. 2 and 10 to the EXPANDED-USE mode shown in FIG. 3 and suggesting camming engagement of the crossbar cam ramp on the pivotable crossbar latch with the step-support crossbar in FIG. 13 during clockwise pivoting rotation of the rear leg unit relative to the front leg unit about the leg-pivot axis to cause locking engagement of the latch on the crossbar as shown in FIG. 14;

FIG. 10 is a perspective view of the foldable step stool of FIGS. 1-8 in which the frame is shown in the COLLAPSED-STORAGE mode after it has been laid flat on an underlying surface to cause the releasable step-retainer lock to face upwardly and prior to being opened to change the frame to an EXPANDED-USE mode shown in FIG. 3 in the step-stool-opening sequence illustrated in FIGS. 10-14;

FIG. 11 is an enlarged view of a portion of the underside of the metal top step of the foldable step stool shown in FIG. 10 showing the pivotable crossbar latch in the NORMAL READY position;

FIGS. 12-14 show a step-stool-opening sequence in which the rear leg unit pivots in a clockwise direction about a leg-pivot axis relative to the front leg unit to illustrate pivoting movement of the metal top step in response to relative pivoting movement of the rear and front leg units;

FIGS. 15 and 16 show initial stages of a step-stool-closing sequence in which a step-stool user uses the finger grip of the pivotable crossbar latch to grasp the releasable step-retainer lock and pivot the pivotable crossbar latch in a counterclockwise direction about the latch-pivot axis away from the NORMAL READY position shown in FIG. 15 and against a torque established by the latch pivoter to the TEMPORARY RETRACTED position shown in FIG. 16 to release the pivotable crossbar latch from the step-support crossbar to allow the rear leg unit to pivot in a counterclockwise direction about the leg-pivot axis toward the front leg unit during closing of the step stool;

FIG. 17 is an enlarged view of a portion of the underside of the metal top step of a foldable step stool including a releasable step-retainer lock in accordance with a second embodiment of the present disclosure in which the latch base of the releasable step-retainer lock is made of metal and the latch mount comprises weldment that is used to couple the metal latch base to a rim front wall of the rim of the metal top step as shown in FIG. 18A1 without forming any fastener-receiver holes or other blemishes in the topside of the metal top step;

FIG. 18A is an enlarged perspective view of the second embodiment of the releasable step-retainer lock when the frame of the step stool is in the COLLAPSED-STORAGE mode showing that the pivotable crossbar latch has been coupled to the latch base at a latch-pivot axis using a latch-pivot axle and moved by a latch pivoter to assume a NORMAL READY position in response to a counterclockwise torque applied by the latch pivoter about the latch-pivot axis, and further showing a latch base made of metal and formed without an anchor-receiver channel to be welded directly to a rim front wall of the metal top step using weldment as shown in FIG. 18A1;

FIG. 18B is an enlarged perspective view of the second embodiment of the releasable step-retainer lock when the frame of the step stool is in the EXPANDED-USE mode showing the pivotable crossbar latch in a TEMPORARY RETRACTED position resulting from the pivotable crossbar latch pivoting about the latch-pivot axis in opposition to a counterclockwise torque applied by the latch pivoter;

FIG. 18A1 is a sectional view taken along line 18A1-18A1 of FIG. 18A showing engagement of a second of the rearwardly extending two stop tabs included in the pivotable crossbar latch with a companion second of the rearwardly extending two latch-pivot blockers included in the metal latch base when the frame of the step stool is in the COLLAPSED-STORAGE mode ensuring that the pivotable crossbar latch does not over rotate in a counterclockwise direction about the latch-pivot axis when the frame is in the COLLAPSED-STORAGE mode to orient the crossbar cam ramp of the pivotable crossbar latch properly in the NORMAL READY position to face toward the step-support crossbar during closing of the step stool as suggested in FIGS. 15 and 16;

FIG. 18B1 is a sectional view taken along line 18B1-18B1 of FIG. 18B showing the separation of the second stop tab of the pivotable crossbar latch from the second latch-pivot blocker of the latch base in response to clockwise rotation of the pivotable crossbar latch about the latch-pivot axis in opposition to a counterclockwise torque applied by the latch pivoter to assume the TEMPORARY RETRACTED position disengaging the step-support crossbar;

FIG. 19 is an exploded perspective assembly view of the second embodiment of the releasable step-retainer lock of the step stool;

FIG. 20A is an enlarged perspective view of a portion of an alternative releasable step-retainer lock showing that a pivotable crossbar latch is mounted on a latch-pivot axle that is coupled to a latch base forming a C-channel so as to support the pivotable crossbar latch for movement about a latch-pivot axis;

FIG. 20B is a view similar to FIG. 20A showing the pivotable crossbar latch after it has been pivoted by a step-stool user as about the latch-pivot axis in a away from the latch-pivot blocker to assume a TEMPORARY RETRACTED position so that the latch can be disengaged from a crossbar.

### DETAILED DESCRIPTION

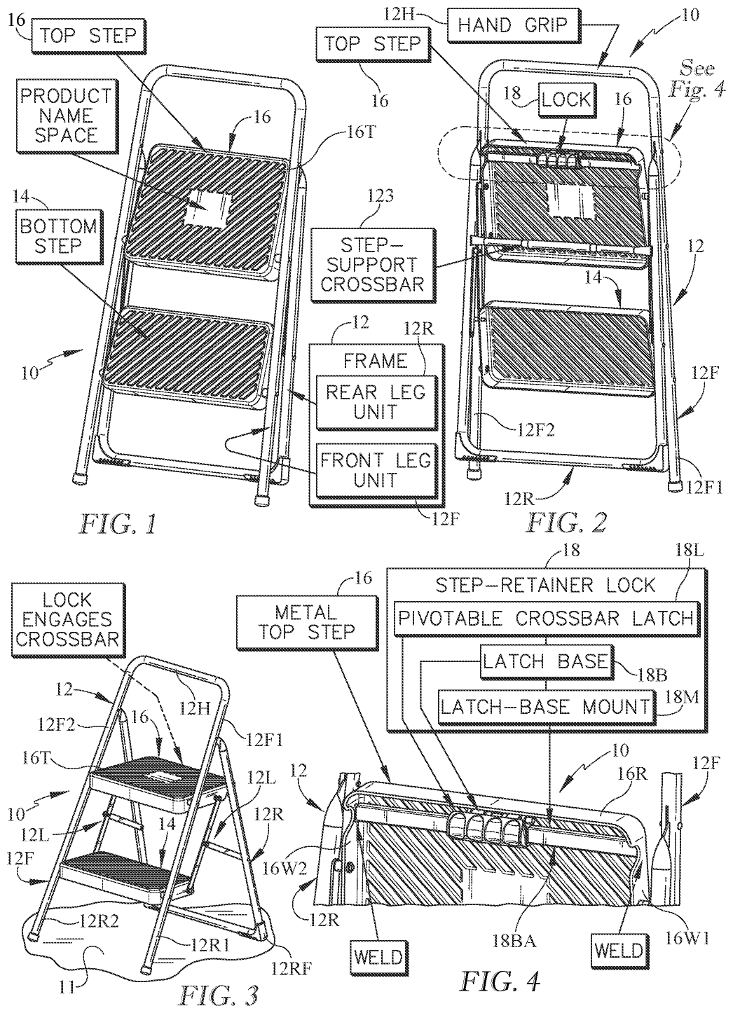

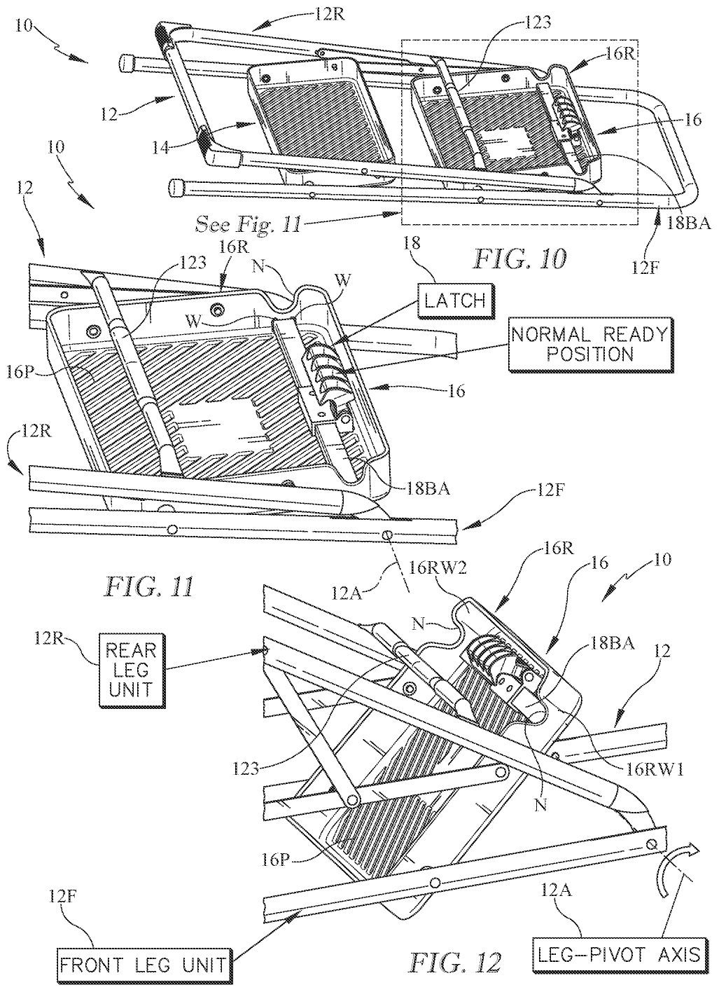

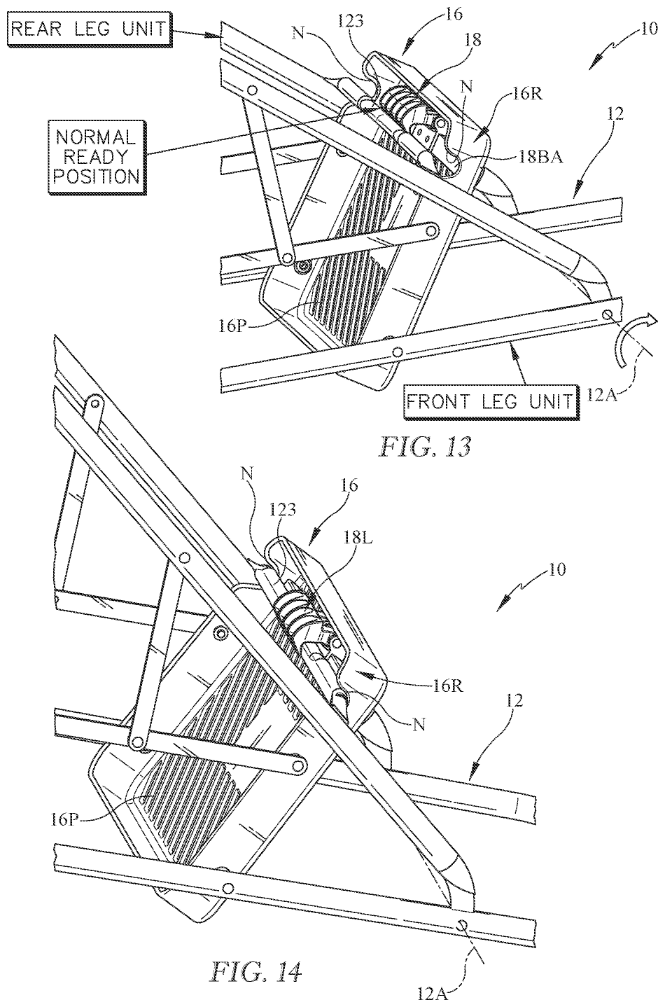

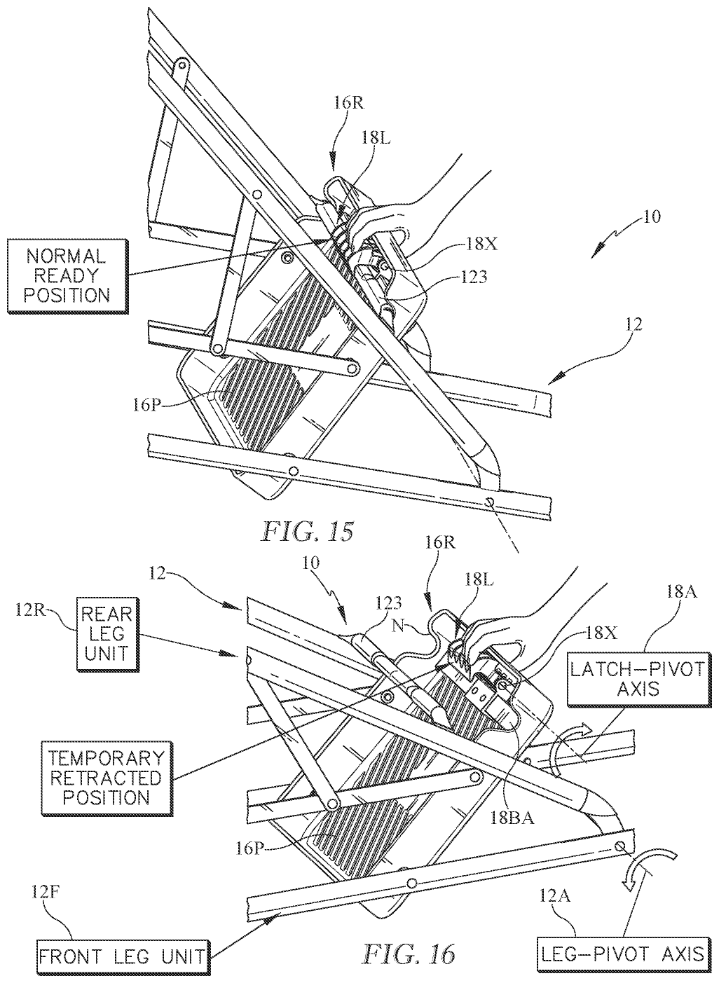

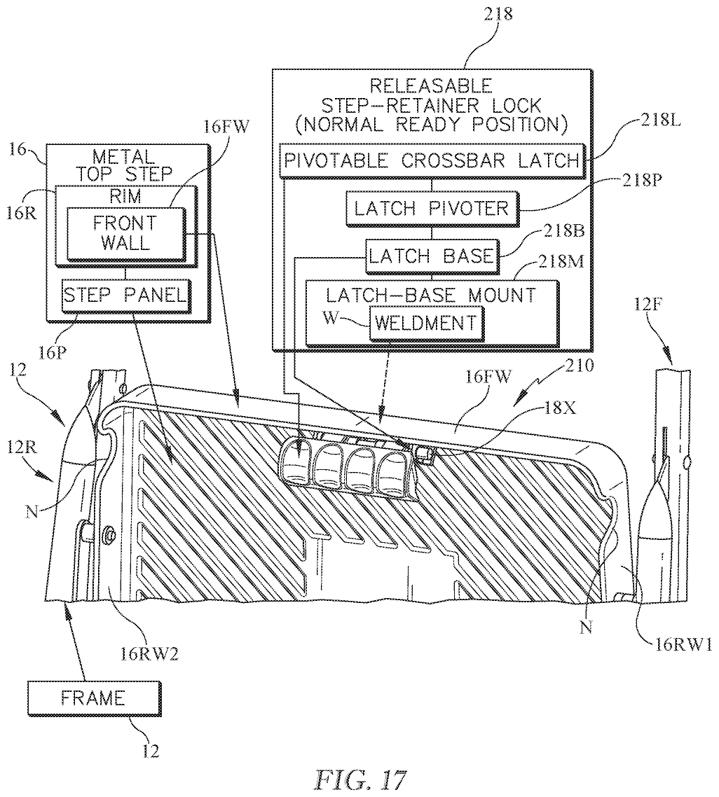

A foldable step stool 10 in accordance with the present disclosure includes an expandable frame 12 that can be changed by a user in the field from a COLLAPSED-STORAGE mode shown in FIGS. 1 and 2 to an EXPANDED-USE mode shown in FIG. 3. A first embodiment of step stool 10 is shown in FIGS. 1-8. A variation in one of the components in step stool 10 is shown in FIG. 9. Opening of the foldable step stool 10 is illustrated in FIGS. 10-14 while an initial stage of closing of step stool 10 is shown in FIGS. 15-16. A foldable step stool 210 in accordance with a second embodiment of the present disclosure is shown in FIGS. 17-19.

Step stool 10 also includes a bottom step 14 pivotably coupled to frame 12, a metal top step 16 that is pivotably coupled to frame 12, and a releasable step-retainer lock 18 that is mounted on the underside of metal top step 16 in accordance with the present disclosure without forming any unwanted holes or other blemishes in a topside 16T of metal top step 16 as suggested in FIGS. 1, 3, and 6. Releasable step-retainer lock 18 can be operated by a user as suggested in FIGS. 15-16 to unlock frame 12 so it can be changed from the EXPANDED-USE mode shown in FIGS. 3, 7, and 15 to the COLLAPSED-STORAGE mode shown in FIGS. 1 and 2 during closing of the foldable step stool 10.

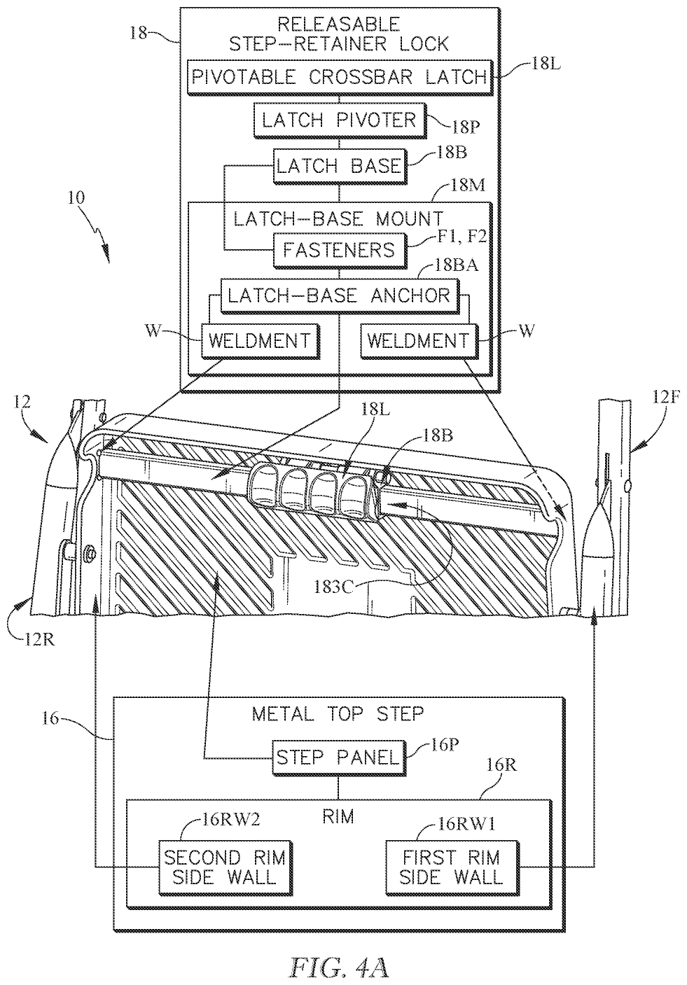

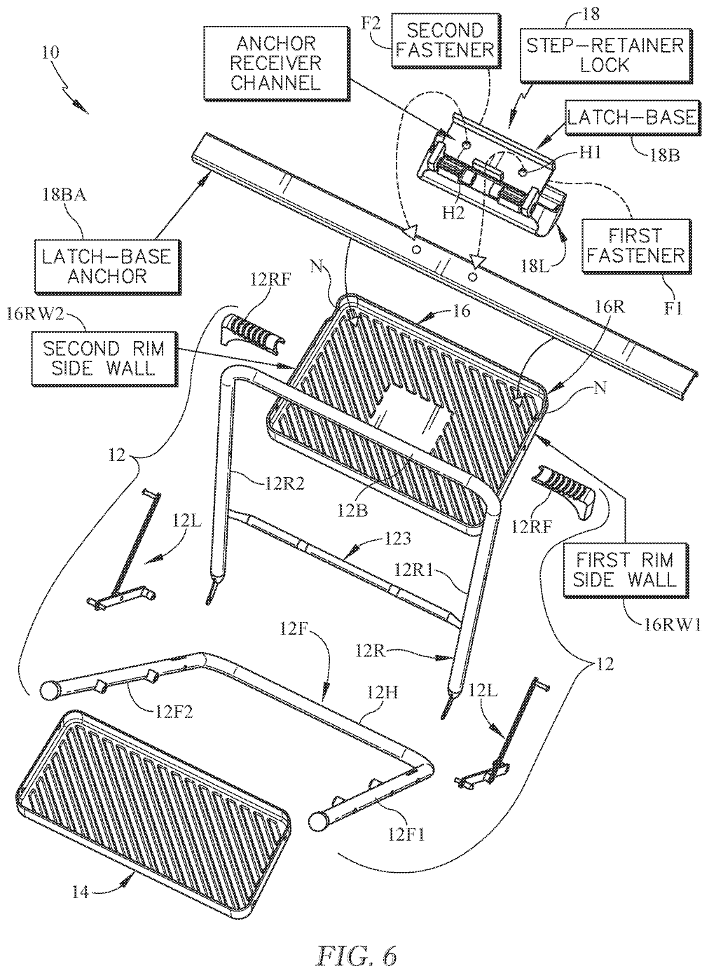

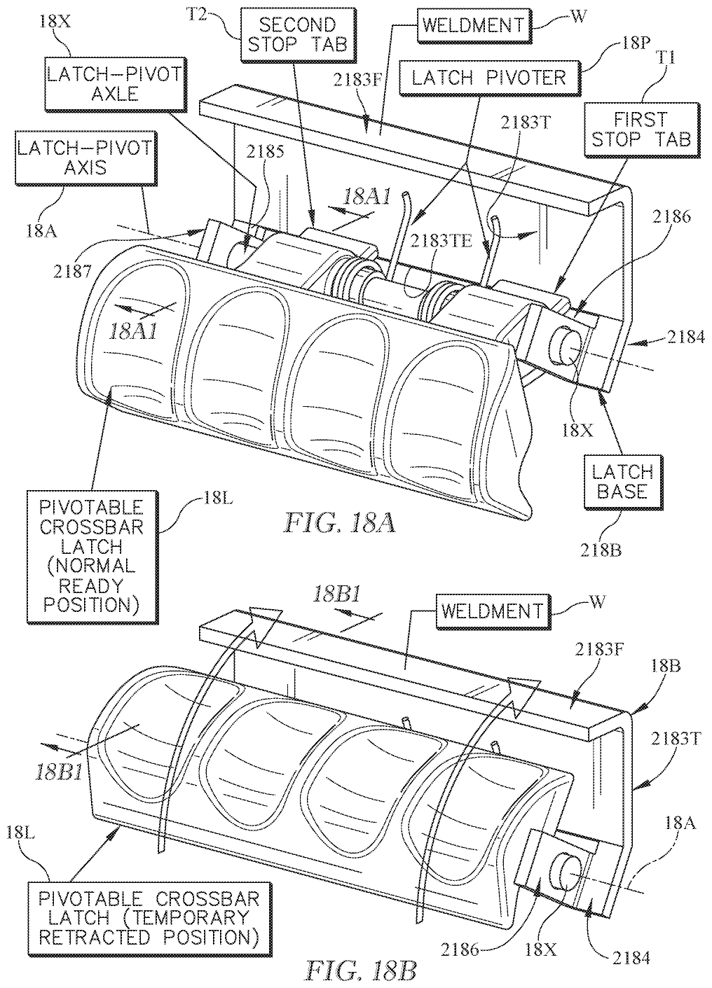

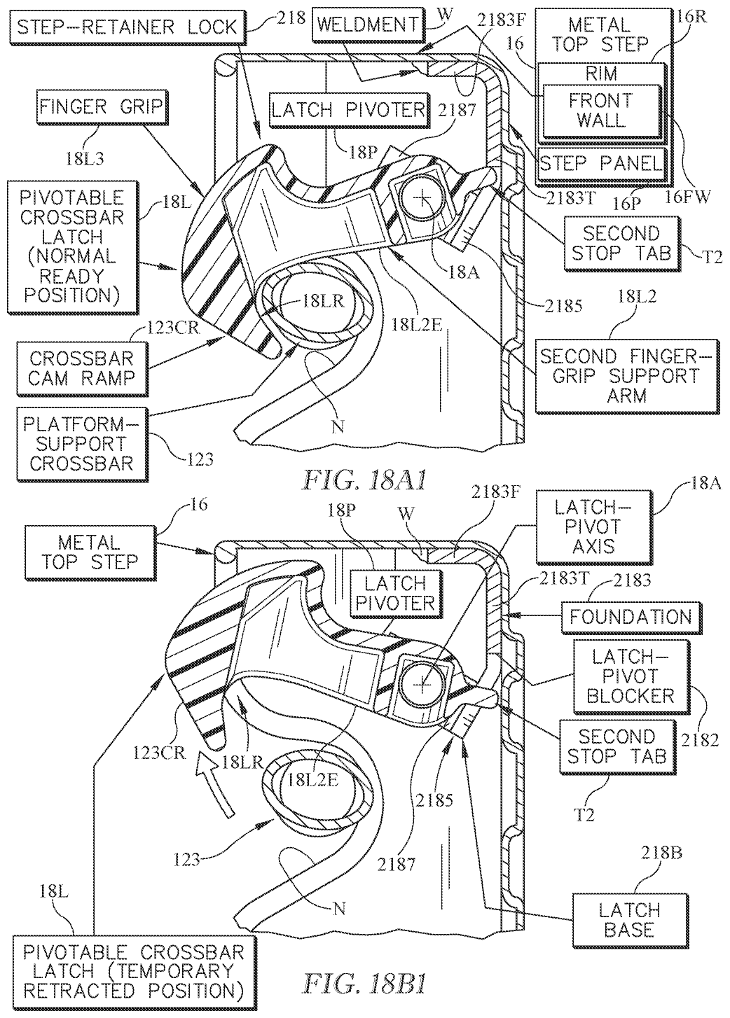

In a first embodiment, shown in FIGS. 1-9, a releasable step-retainer lock 18 includes a pivotable crossbar latch 18L that is pivotably mounted on a latch base 18B made of a plastics material and that is fastened using fasteners F1, F2 to a metal latch-base anchor 18B that is also included in step-retainer lock 18 as suggested in FIG. 6 and welded to metal top step 16 as suggested in FIG. 4. In a second embodiment shown in FIGS. 17-19, an alternative releasable step-retainer lock 218 includes a pivotable crossbar latch 18L that is pivotably mounted on a metal latch base 218B that is welded to metal top step 16 as suggested, for example, in FIGS. 17 and 18A1.

Releasable step-retainer lock 18 is coupled to metal top step 16 to move therewith and is used to retain metal top step 16 automatically in a stationary position on a step-support crossbar 123 included in frame 12 when frame 12 assumes the EXPANDED-USE mode during opening of foldable step stool 10 as suggested diagrammatically in FIG. 3 in an illustrative sequence shown in FIGS. 10-14. Initial stages of closing of foldable step stool 10 are shown in FIGS. 15 and 16 in which a user grasps a pivotable crossbar latch 18L of step-retainer lock 18 and pivots latch 18L in a clockwise direction about a latch-pivot axis 18A to separate step-retainer lock 18 from step-support crossbar 123 to free frame 12 to begin to collapse to assume its COLLAPSED-STORAGE mode.

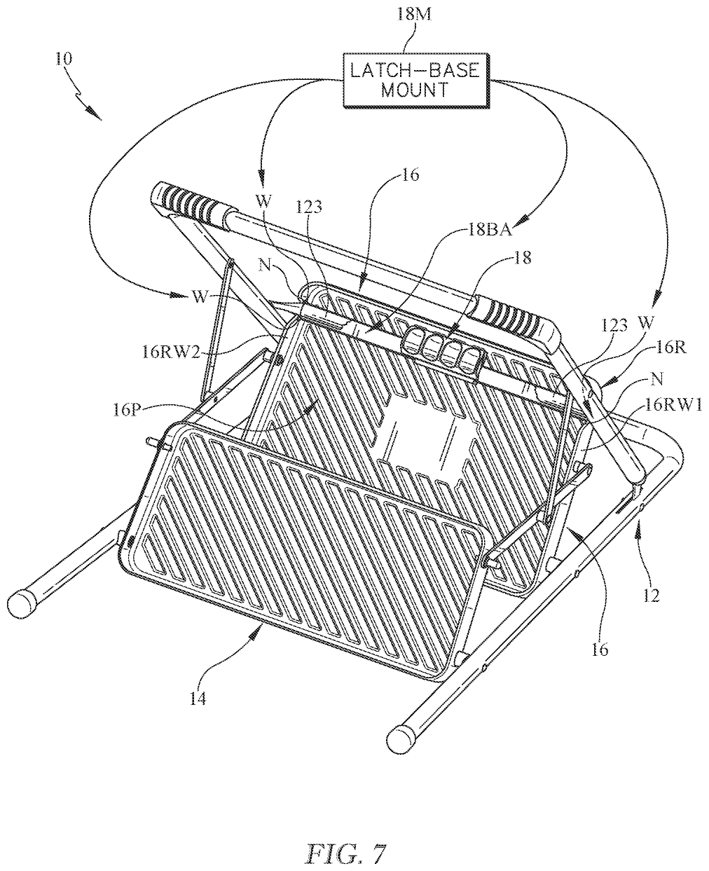

A foldable step stool 10 in accordance with the present disclosure includes a frame 12 configured to be changed by a user from a COLLAPSED-STORAGE mode, as shown in FIGS. 1 and 2, to an EXPANDED-USE mode, as shown in FIGS. 3 and 7. Step stool 10 is in the EXPANDED-USE mode when a step-support crossbar 123 and a releasable step-retainer lock 18 engage one another, as shown in FIG. 7.

In a first embodiment, as shown in FIGS. 1-9, releasable step-retainer lock 18 includes a pivotable crossbar latch 18L, a latch base 18B, and a weldable metal latch-base anchor 18BA that can be welded to an underside of metal top step 16 and mated with latch base 18B using base fasteners F1, F2. Latch base 18B is made of a plastics material and is anchored to the weldable latch-base anchor 18BA using base-fasteners F1, F2 such that a topside 16T of metal top step 16 of step stool 10 is free of fastener-receiver holes or other blemishes, as shown in FIG. 1.

In a second embodiment, as shown in FIGS. 17-19, releasable step-retainer lock 218 includes pivotable crossbar latch 218L and a weldable latch base 218B. Latch base 218 is made of a metal material and is welded to an underside of metal top step 16 such that topside 16T of metal top step 16 of step stool 210 is free of fastener-receiver holes or other blemishes in accordance with the present disclosure.

A sequence of opening step stool 10 to cause frame 12 to change from the COLLAPSED-STORAGE mode to the EXPANDED-USE mode is shown in FIGS. 10-14. A partial sequence of closing step stool 10 is shown in FIGS. 15-16.

Pivotable crossbar latch 18L is oriented in accordance with the present disclosure to engage step-support crossbar 123 of frame 12 when step stool 10 is opened to place frame 12 in its EXPANDED-USE mode. Pivotable crossbar latch 18L can be pivoted by a user to disengage step-support crossbar 123 as suggested in FIGS. 15 and 16 during closing of step stool 10 to place frame 12 in its COLLAPSED-STORAGE mode. Each of step-retainer locks 18 and 218 is coupled to metal top step 16 in accordance with the present disclosure to move therewith during opening and closing of foldable step stool 10 using weldment material (W) that is included in locks 18 and 218 without forming any fastener-receiver holes or blemishes in metal top step 16.

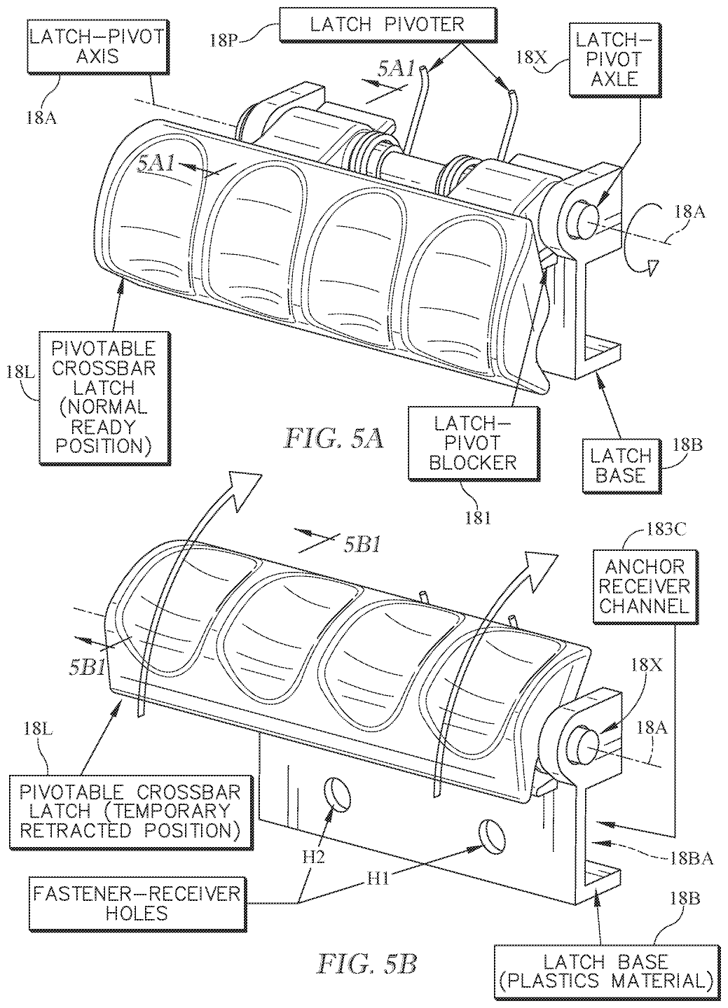

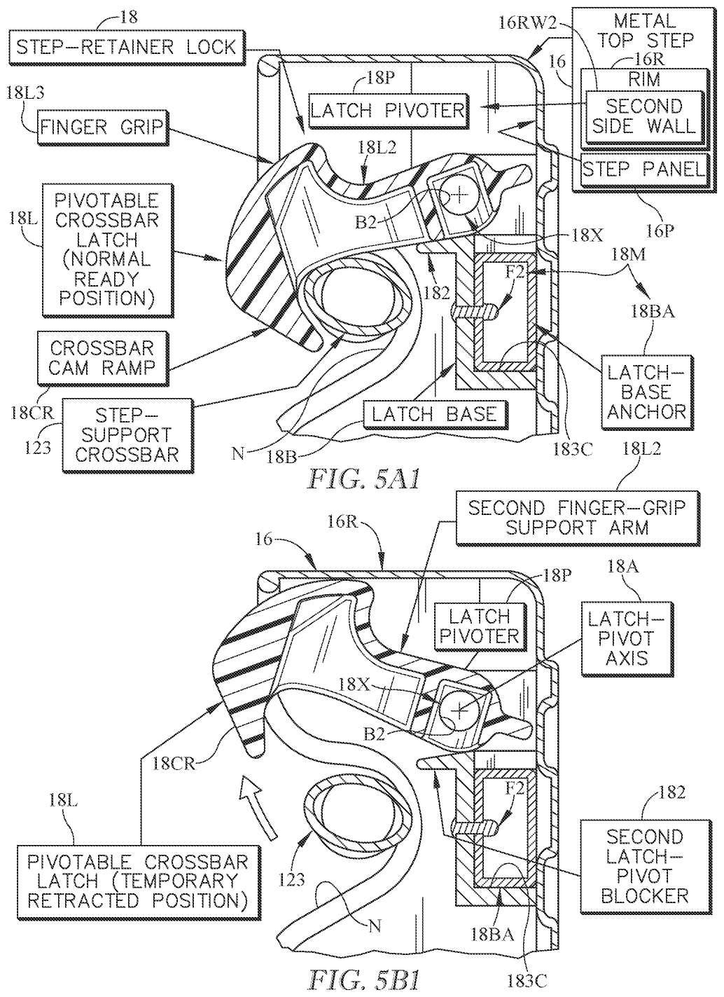

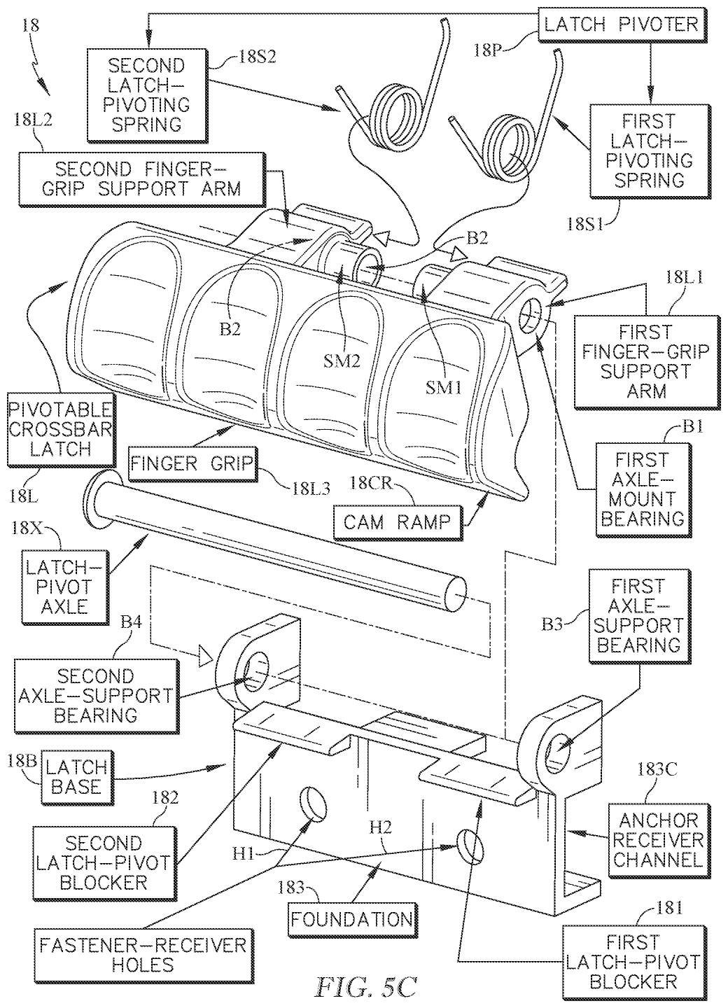

In a first embodiment, latch-base anchor 18BA of releasable step-retainer lock 18 is mounted in a stationary position on underside of metal top step 16, as shown in FIG. 4. As suggested in FIG. 5, releasable step-retainer lock 18 also includes a latch base 18B that is made of a plastics material and formed to include two fastener-receiver holes H1, H2, a latch-pivot axle 18X that is supported for rotation in first and second axle-support bearings B3, B4 formed in latch base 18B about a latch-pivot axis 18A, and a pivotable crossbar latch 18L that is adapted to be mounted on latch-pivot axle 18X for pivotable movement about latch-pivot axis 18A.

A latch mount 18M is included in step-retainer lock 18 as suggested in FIGS. 4 and 4A. Latch mount 18 is configured in accordance with the present disclosure to include a metal latch-base anchor 18BA that can be (1) welded to an underside of metal top step 16 using weldment (W) and (2) coupled to the plastic latch base 18B using base fasteners F1, F2. Plastic latch base 18B is formed to include an anchor receiver channel 183C for receiving a middle portion of metal latch-base anchor 18BA therein as suggested in FIGS. 4A-5C to mate metal latch-base anchor 18BA to plastic latch base 18B before base fasteners F1, F2 are used to couple plastic latch base 18B to metal latch-base 18BA. Metal latch-base anchor 18BA is coupled to the underside of step panel 16P of metal top step 16 using weldment (W) as suggested in FIG. 4A while latch-base anchor 18BA engages an underside of step panel 16P of metal top step, a first end of latch-base anchor 18BA is coupled to a first rim side wall 16RW of rim 16B of metal top step 16 and using weldment (W) and an opposite second end of latch-base member 18BA is coupled to a second rim side wall 16RW2 using weldment (W) as suggested in FIG. 4A.

Step-retainer lock 18 also includes a latch pivoter 18P comprising first and second latch-pivoting springs 18S1, 18S2 that is adapted to be mounted on first and second axle-mount bearings B1, B2 and arranged to act against metal top step 16 to urge pivotable crossbar latch 18L to pivot about latch-pivot axis 18A to assume its NORMAL READY position shown in FIGS. 2, 4, 5A, 5A1, and 10. Releasable step-retainer lock 18 is separated from step-support crossbar 123 when frame 12 of step stool 10 is in the COLLAPSED-STORAGE mode after step stool 10 has been closed, as shown in FIG. 2. Releasable step-retainer lock 18 is configured to engage step-support crossbar 123 when frame 12 of step stool 10 is in the EXPANDED-USE mode after step stool 10 has been opened, as shown in FIG. 7.

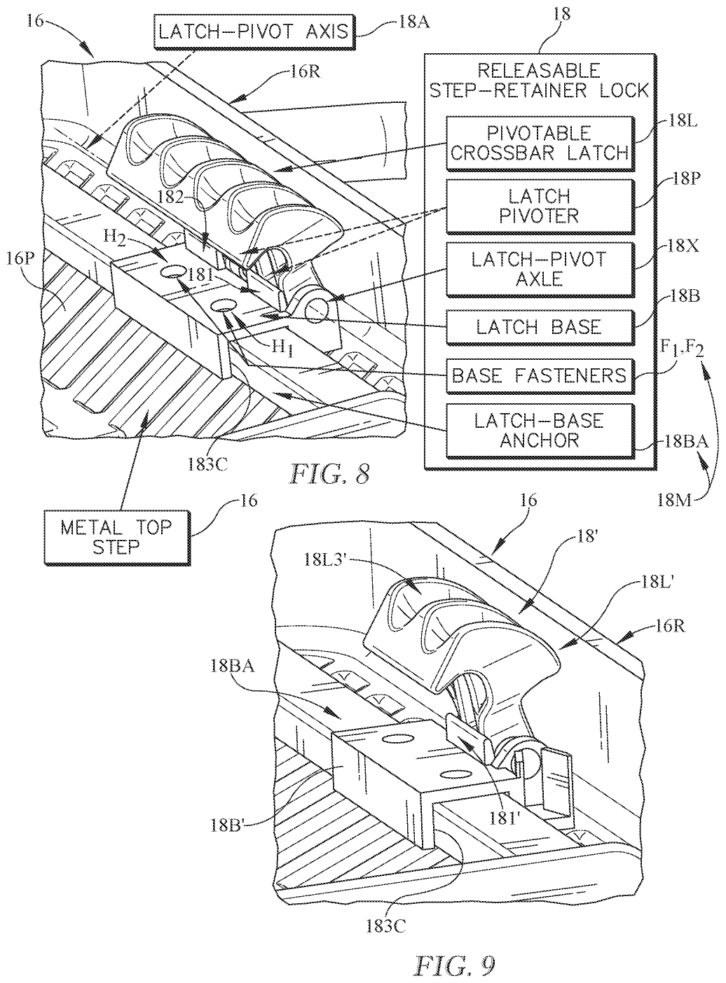

Releasable step-retainer lock 18 includes pivotable crossbar latch 18L, a latch pivoter 18P, a latch-pivot axle 18X, and a latch base 18B formed to include fastener-receiver holes H1, H2 and first and second latch-pivot blockers 181, 182, and a latch mount 18M including base fasteners F1, F2 and a latch-base anchor 18BA, as shown in FIG. 8. Pivotable crossbar latch 18L is coupled to latch base 18B at a latch-pivot axis 18A through the use of a latch-pivot axle 18X, as shown in FIGS. 5A and 5B. Latch base 18B is coupled to latch-base anchor 18BA using base fasteners F1, F2 that are inserted through fastener-receiver holes H1, H2 formed in latch base 18B to engage a portion of latch-base anchor 18BA, as suggested in FIG. 4. Latch-base anchor 18BA is made of metal and is welded at opposite ends thereof to each of a first side wall 162RW1 of a rim 16R and a second side wall 162RW2 of rim 16R of metal top step 16, as shown in FIG. 4, which enables topside 16T of metal top step 16 to be free of fastener-receiver holes or other blemishes in accordance with the present disclosure.

While frame 12 is in the COLLAPSED-STORAGE mode, a latch pivoter 18P included in step-retainer lock 18 is biased to rotate pivotable crossbar latch 18L about latch-pivot axis 18A in a counterclockwise direction to engage first and second latch-pivot blockers 181, 182 of latch base 18B as shown in FIGS. 5A1 and 8. This engagement blocks further counterclockwise rotation of pivotable crossbar latch 18B about latch-pivot axis 18A when frame 12 of step stool 10 is in the COLLAPSED-STORAGE mode such that pivotable crossbar latch 18 does not over rotate and thus is oriented to engage and cam on step-support crossbar 123 during closing of step stool 10 as suggested in FIGS. 15 and 16.

When transitioning frame 12 of step stool 10 to the EXPANDED-USE mode during opening of step stool 10, pivotable crossbar latch 18L pivots about latch-pivot axis 18A using latch pivoter 18P, as suggested by FIG. 5B. Pivotable crossbar latch 18L engages step-support crossbar 123 to support frame 12 of step stool 10 in the EXPANDED-USE mode, as shown in FIG. 7. First and second latch pivot blockers 181, 182 of latch base 18B are separated from pivotable crossbar latch 123 while frame 12 of step stool 10 is in the EXPANDED-USE mode, as shown in FIG. 5A2.

Foldable step stool 10, as shown in FIG. 1, includes frame 12, metal top step 16, a bottom step 14, and releasable step-retainer lock 18. Frame 12 supports metal top step 16 and bottom step 14 for pivotable movement about companion step-pivot axes associated with each of metal top step 16 and bottom step 14 as frame 12 changes from its COLLAPSED-STORAGE mode, as shown in FIGS. 1 and 2, to its EXPANDED-USE mode, as shown in FIGS. 3 and 7. Metal top step 16 provides space on topside 16T on which a step-stool user may stand when frame 12 is in EXPANDED-USE mode. Bottom step 14 is relatively smaller than metal top step 16 and located closer to a floor 11 under the step stool 10 when frame 12 is in EXPANDED-USE mode, as shown in FIG. 3. Releasable step-retainer lock 18 is coupled to metal top step 16, as suggested in FIGS. 2 and 4, and arranged to engage step-support crossbar 123 of frame 12 when frame 12 is in EXPANDED-USE mode, as suggested in FIG. 3. Step stool 10 is unfolded to assume an opened configuration when frame 12 is in COLLAPSED-STORAGE mode. Step stool 10 is folded to assume a closed configuration when frame 12 is in EXPANDED-USE mode.

Frame 12 includes a front leg unit 12F, a rear leg unit 12R pivotably coupled to front leg unit 12F at a leg-pivot axis 12A, and a pair of fold-control linkages 12L, as shown in FIG. 1-3. Linkages 12L cooperate functionally to couple front leg unit 12F to rear leg unit 12R and allow components of frame 12 to pivot about a leg-pivot axis 12A in a controlled manner during a change from COLLAPSED-STORAGE mode to EXPANDED-USE mode. Metal top step 16 and bottom step 14 are pivotably coupled to frame 12.

Front leg unit 12F includes downwardly extending first and second legs 12F1, 12F2 and a handgrip 12H, as shown in FIGS. 1 and 2. Handgrip 12H is arranged to interconnect companion upper ends of first and second legs 12F1, 12F2 as shown in FIG. 3.

Rear leg unit 12R includes an upwardly extending first and second legs 12R1, 12R2, a bottom bar 12B, and step-support crossbar 123, as shown in FIG. 2. Bottom bar 12B is arranged to interconnect companion lower ends of first and second legs 12R1, 12R2 as shown in FIG. 3. Upwardly extending legs 12R1, 12R2 of rear leg unit 12R are pivotably coupled to downwardly extending legs 12F1, 12F2 of front leg unit 12F to pivot about leg-pivot axis 12A during opening and closing of foldable step stool 10. Step-support crossbar 123 interconnects middle portions of upwardly extending first and second legs 12R1, 12R2 of rear leg unit 12R, as shown in FIG. 2. Step-support crossbar 123 and bottom bar 12B are arranged to lie in spaced-apart parallel relation to one another as shown in FIG. 2.

Releaseable step-retainer lock 18 is coupled to an underside of metal top step 16, as shown in FIGS. 4 and 4A. Releaseable step-retainer lock 18 includes pivotable crossbar latch 18L, latch base 18B, and a latch mount 18M including a weldable latch-base anchor 18BA and base fasteners F1, F2. Weldable latch-base anchor 18BA of releaseable step-retainer lock 18 mates with metal top step 16, as shown in FIG. 4. Base fasteners F1, F2 are used to coupled latch base 18B to latch-base anchor 18BA.

Pivotable crossbar latch 18L is coupled to latch base 18 to pivot about a latch-pivot axis 18A, as shown in FIGS. 5A and 5B. Pivotable crossbar latch 18L includes a finger grip 18L3, and first and second finger grip-support arms 18L1, 18L2, as shown in FIG. 5C. Finger grip 18L3 is formed to include four finger-receiving channels as shown, for example, in FIG. 5C to facilitate gripping of pivotable crossbar latch 18L by a step-stool user during use as suggested in FIGS. 15 and 16.

Each of first and second finger-grip support arms 18L1, 18L2 interconnect finger grip 18L3 and latch-pivot axle 18X as suggested in FIGS. 5B1 and 5C. A proximal end of first finger-grip support arm 18L1 is formed to include a first axle-mount bearing B1 that is sized to receive latch-pivot axle 18X therein to establish rotative bearing engagement of latch-pivot axle 18X and first finger-grip support arm 18L1 during pivotable movement of pivotable crossbar latch 18L about latch-pivot axis 18A. A proximal end of second finger-grip support arm 18L2 is formed to include a second axle-mount bearing B2 that is sized to receive latch-pivot axle 18X therein as suggested in FIGS. 5A1, 5B1, and 5C to establish rotative bearing engagement of latch-pivot axle 18X and second finger-grip support arm 18L2 during pivoting movement of pivotable crossbar latch 18L about latch-pivot axis 18A.

Latch pivoter 18P biases pivotable crossbar latch 18L from a NORMAL READY position, as shown in FIG. 5A, to a TEMPORARY RETRACTED position, as shown in FIG. 5B. Latch pivoter 18P includes a first latch-pivoting spring 18S1 mounted on a first spring mount SM1 included in pivotable crossbar latch 18L and a second latch-pivoting spring 18S2 mounted on a second spring mount SM2 included in pivotable crossbar latch 18L as suggested in FIGS. 5A and 5C.

First and second finger grip-support arms 18L1, 18L2 each include first and second axle-mount bearings B1, B2, first and second spring mounts SM1, SM2, and first and second stop tabs T1, T2, as shown in FIG. 5C. First and second axle-mount bearings B1, B2 couple pivotable crossbar latch 18L to latch base 18B using latch-pivot axle 18X. First and second spring mounts SM1, SM2 are arranged to support latch pivoter 18P. Illustratively, latch pivoter 18P includes a first torsion spring 1851 mounted on first spring mount SM1 and a second torsion spring 18S2 mounted on second spring mount SM2 as shown in FIG. 5A. First and second stop tabs T1, T2 are an operative feature of pivotable crossbar latch 218 in the second embodiment shown in FIGS. 17-19, but not the first embodiment shown in FIGS. 1-9. Pivotable crossbar latch 18L is interchangeable and may be used in step stool 10 or 210.

First and second axle-mount bearings B1, B2 accept latch-pivot axle 18X, as suggested by FIG. 5C. Latch-pivot axle 18X pivotably connects pivotable crossbar latch 18L to latch base 18B for pivotable movement about latch-pivot axis 18A.

Finger grip 18L3 is mounted on first and second finger grip-support arms 18L1, 18L2, as shown in FIG. 5C. In one embodiment, finger grip 18L3 has four finger-receiver grooves, as shown in FIGS. 2, 4, 5A, 5B, 5C, and 8. In another embodiment, finger grip 18L3′ has two finger-receiver grooves, as shown in FIG. 9. Step-stool user grips finger grip 18L3 when step stool 10 is in the unfolded position to transform step stool 10 to the folded position, as suggested by FIGS. 15 and 16.

Latch mount 18M functions to couple latch base 18B to underside of metal top step 16, as suggested in FIG. 4. In the first embodiment shown in FIGS. 1-9, latch base 18B includes first and second latch-pivot blockers 181, 182 and foundation 183. Foundation 183 is formed to include fastener-receiver holes H1, H2 for receiving base fasteners F1, F2, anchor-receiver channel 183C for receiving latch-base anchor 18BA, and first and second axle-support bearings B3, B4 for receiving latch-pivot axle 18X, as shown in FIG. 5C. First and second latch-pivot blockers 181, 182 are cantilevered to and arranged to extend away from foundation 183 of latch base 18B as shown in FIG. 5C. Fastener-receiver holes H1, H2 are arranged to receive companion base fasteners F1, F2 that function to couple latch base 18B to latch-base anchor 18BA, as suggested by FIG. 6. Anchor-receiver channel 183C is formed in foundation 183 of latch base 18B and is sized to receive latch-base anchor 18BA, as suggested by FIG. 6. First and second axle-support bearings B3, B4 receive latch-pivot axle 18X therein to couple latch base 18B to pivotable crossbar latch 18L using latch-pivot axle 18X, as suggested by FIG. 5C.

First and second latch-pivot blockers 181, 182 of latch base 18 cooperate to engage first and second finger-grip support arms 18L1, 18L2 of pivotable crossbar latch 18L when frame 12 of step stool 10 is in the COLLAPSED-STORAGE mode, as shown in FIG. 5A1. The engagement ensures pivotable crossbar latch 18L does not over rotate so as to remain in a NORMAL READY position. When frame 12 of step stool 10 is in the EXPANDED-USE mode, first and second latch-pivot blockers 181, 182 of latch base 18B are separated from companion first and second finger-grip support arms 18L1, 18L2 of latch 18L, as shown in FIG. 5B1 and suggested in FIG. 5B. In the EXPANDED-USE mode, pivotable crossbar latch 18L engages step-support crossbar 123 to cause first and second latch-pivot blockers 181, 182 to be spaced apart from first and second finger-grip support arms 18L1, 18L2. Instead of first and second finger-grip support arms 18L1, 18L2 engaging first and second latch-pivot blockers 181, 182, first and second finger-grip support arms 18L1, 18L2 engage step-support crossbar 123.

Foundation 183 of latch base 18B is configured to form anchor-receiver channel 183C to receive latch-base anchor 18BA therein, as shown in FIG. 5C. Foundation 183 includes fastener-receiver holes H1, H2 that allow latch base 18B to be attached to latch-base anchor 18BA using base fasteners F1, F2 extending through fastener-receiver holes H1, H2, as suggested in FIG. 6.

Anchor receiver channel 183C of foundation 183 of latch base 18B includes a top, a back, and a bottom, as shown in FIG. 5C. Top, back, and bottom are arranged to form anchor receiver channel 183C and to fit around latch-base anchor 18BA, as suggested by FIGS. 4 and 6. Anchor receiver channel 183C of foundation 183 allows latch base 18B to be coupled to latch-base anchor 18BA using base fasteners F1, F2.

First and second axle-support bearings B3, B4 extend upwardly from foundation 183 of latch base 18B, as shown in FIG. 5C. First and second axle-support bearings B1, B2 allow latch-pivot axle 18X to pass through to cause latch-pivot axle 18X to connect first and second axle-support bearings B3, B4 of latch base 18B to first and second axle-mount bearings B1, B2 of pivotable crossbar latch 18L, as suggested in FIG. 5C.

Step stool 10 including a metal top step 16, a relatively smaller bottom step 14, and an expandable frame 12 configured to support metal top step 16 and bottom step 14 during a change in frame 12 from a COLLAPSED-STORAGE mode shown in FIGS. 1 and 2 to an EXPANDED-USE mode shown in FIG. 3. Frame 12 includes a front leg unit 12P pivotably coupled to a rear leg unit 12R. Topside 16T of metal top step 16 is free of fastener-receiver holes or other blemishes in accordance with the present disclosure.

Step-support crossbar 123 of frame 12 is arranged to interconnect upwardly extending first and second legs of rear frame unit 12R to cause step-support crossbar 123 to lie in spaced-apart parallel relation to a handgrip 12H included in front leg unit 12F as suggested in FIG. 2. A releasable step-retainer lock 18 is mounted in a stationary position on an underside of metal top step 16 and arranged to lie in unlocked separated relation to step-support crossbar 123 when frame 12 is in the COLLAPSED-STORAGE mode as shown in FIG. 2 and to lie in locked engaged relation to step-support crossbar 123 when frame 12 is expanded to assume the EXPANDED-USE mode as suggested in FIGS. 3 and 7 so that metal top step 16 is retained in a stationary position relative to step-support crossbar 123 of frame 12 to stabilize the expanded frame 12 once step stool 10 is opened.

Opposite ends of latch-base anchor 18BA of latch mount 18M of step-retainer lock 18 are welded to opposing first and second rim side walls 16RW1, 16RW2 of metal top step 16 using weldment (W) to hold latch-base anchor 18BA in a stationary position on the underside of metal top step 16. The releasable step-retainer lock 18 also includes a pivotable crossbar latch 18L and a latch base 18B that is coupled to the stationary welded latch-base anchor 18BA as suggested in FIGS. 6 and 7 without coupling latch base 18B directly to metal top step 16 using fasteners or other components. Each of first and second rim side walls 16RW1, 16RW2 of metal top step 16 is formed to include a crossbar-receiving notch (N) that is sized to accept step-support crossbar 123 of frame 12 therein when frame 12 is in the EXPANDED-USE mode as shown in FIG. 14.

Frame 12 of step stool 10 is in the COLLAPSED-STORAGE mode as shown in FIG. 5A. The pivotable crossbar latch 18 is mounted on a latch-pivot axle 18A that is coupled to latch base 18B for pivotable movement about latch-pivot axis 18A. Latch pivoter 18P is associated with latch-pivot axle 18X and provides means for yieldably pivoting pivotable crossbar latch 18L about latch-pivot axis 18A to assume a NORMAL READY position in engagement with one of the latch-pivot blockers 181, 182 included in latch base 18B and shown in FIG. 5C.

Pivotable crossbar latch 18L is shown in FIG. 5B after it has been pivoted by a step-stool user as suggested in FIG. 16 about latch-pivot axis 18A in a clockwise direction away from latch-pivot blocker 181 to assume a TEMPORARY RETRACTED position to load latch pivoter 181 so that latch 18L can be disengaged from crossbar 123 as suggested in FIGS. 15 and 16 during a change of frame 12 of step stool 10 from the EXPANDED-USE mode to the COLLAPSED-STORAGE mode as suggested in FIGS. 14-16. A foundation 183 of latch base 18L is made of a plastics material and is formed to include two fastener-receiver holes H1, H2 for receiving base fasteners F1, F2 as suggested in FIG. 6 to allow latch base 18B to be coupled to metal latch-base anchor 18BA of latch mount 18M without forming any fastener-receiver holes or other blemishes in metal top step 16 in accordance with the present disclosure.

The engagement of a second fingergrip-support arm 18L2 included in the pivotable crossbar latch 18L is suggested in FIG. 5A1 with a second latch-pivot blocker 182 included in foundation 183 of latch base 18B when frame 12 of the foldable step stool 10 is in the COLLAPSED-STORAGE mode ensuring that the pivotable crossbar latch 18L does not over rotate about latch-pivot axis 18A in a counterclockwise direction when frame 12 is in the COLLAPSED-STORAGE mode so that a crossbar cam ramp 18CR formed on the pivotable crossbar latch 18L is oriented properly to engage and cam on and over step-support crossbar 123 as step stool 10 is opened as is apparent from the opening sequence illustrated in FIGS. 10-14. Separation of the second fingergrip-support arm 18L2 from the underlying second latch-pivot blocker 182 on foundation 183 of latch base 18B is shown in FIG. 5B1 as a result of separation of the releasable step-retainer lock 18L from step-support crossbar 123 during closing of the step stool 10 as suggested in FIGS. 15 and 16. Similarly, there is separation of first fingergrip-support arm 18L1 from a companion first latch-pivot blocker 181 on foundation 183 of latch base 18B during closing of step stool 10.

An exploded perspective assembly view of many of the components included in the releasable step retainer lock 18 shown in FIGS. 5A and 5B is provided in FIG. 5C to show that the releasable step retainer lock 18 comprises a pivotable crossbar latch 18L, a latch pivoter 18P including first and second latch-pivoting (torsion) springs 18S1, 18S2, a latch-pivot axle 18X, and a latch base 18B including a foundation 183 formed to include a latch-base anchor-receiver channel 183C and two fastener-receiver holes H1, H2, first and second axle-support bearings B1, B2, and first and second latch-pivot blockers 181, 182. Foundation 182 of latch base 18B is adopted to be coupled to latch-base anchor 18BA using base fasteners F1, F2.

As suggested in FIG. 6, latch-base anchor 18BA of latch mount 18M of step-retainer lock 18 can be moved to engage the underside of metal top step 16 so that the metal latch-base anchor 18BA can be welded to metal top step 16 and that first and second base fasteners F1, F2 can be passed through companion fastener-receiver holes H1, H2 formed in foundation 183 of latch base 18B and the latch-base anchor 18BA to couple the releasable step-retainer lock 18 to metal top step 16 after latch-base anchor 18BA has been welded to metal top step 16 as suggested in FIG. 7 without forming any fastener-receiver holes H1, H2 or other blemishes in the metal top step 16.

Frame 12 of step stool 10 occupies the EXPANDED-USE mode as shown in FIG. 7. Latch-base anchor 18BA of latch mount 18M is welded to the underside of metal top step 16 and mated to latch base 18B to hold the releasable step-retainer lock 18 in a fixed position on metal top step 16.

As suggested in FIG. 8, the plastic latch base 18B of the releasable step-retainer lock 18 is mounted using base fasteners F1, F2 on the metal latch-base anchor 18BA of latch mount 18M that is welded in place on the underside of metal top step 16. First and second latch-pivoting springs 18S1, 18S2 of latch pivoter 18P are biased to rotate the pivotable crossbar latch 18L normally in a counterclockwise direction about a latch-pivot axis 18A to engage first and second latch-pivot blockers 181, 182 of latch base 18B so that further counterclockwise rotation of the pivotable crossbar latch 18L is blocked to establish the NORMAL READY position of the pivotable crossbar latch 18L.

Step panel 16P of metal top step 16 is relatively thin and is formed without fastener-receiver holes in the face of the step panel 16P in accordance with the present disclosure. Weldment (W) included in latch mount 18M is applied in accordance with the present disclosure to rim 16R to avoid burning or otherwise blemishing step panel 16P or visible areas of metal top step 16. Step-retainer lock 18 is configured to be easy for a user to open as no appreciable friction forces need to be overcome during a step-stool opening sequence in accordance with the present disclosure. And plastic latch base 18B of step-retainer lock 18 is coupled to metal top step 16 using a latch mount 18M in accordance with the present disclosure. Base fasteners F1, F2 may be rivets, bolts, pins, or screws or other similar fasteners.

A releasable step-retainer lock 18′ in accordance with another embodiment of the present disclosure is shown in FIG. 9. The pivotable crossbar latch 18L′ includes a finger grip provided with two finger-receiver grooves instead of four finger-receiver grooves shown in the embodiment of FIGS. 1-8.

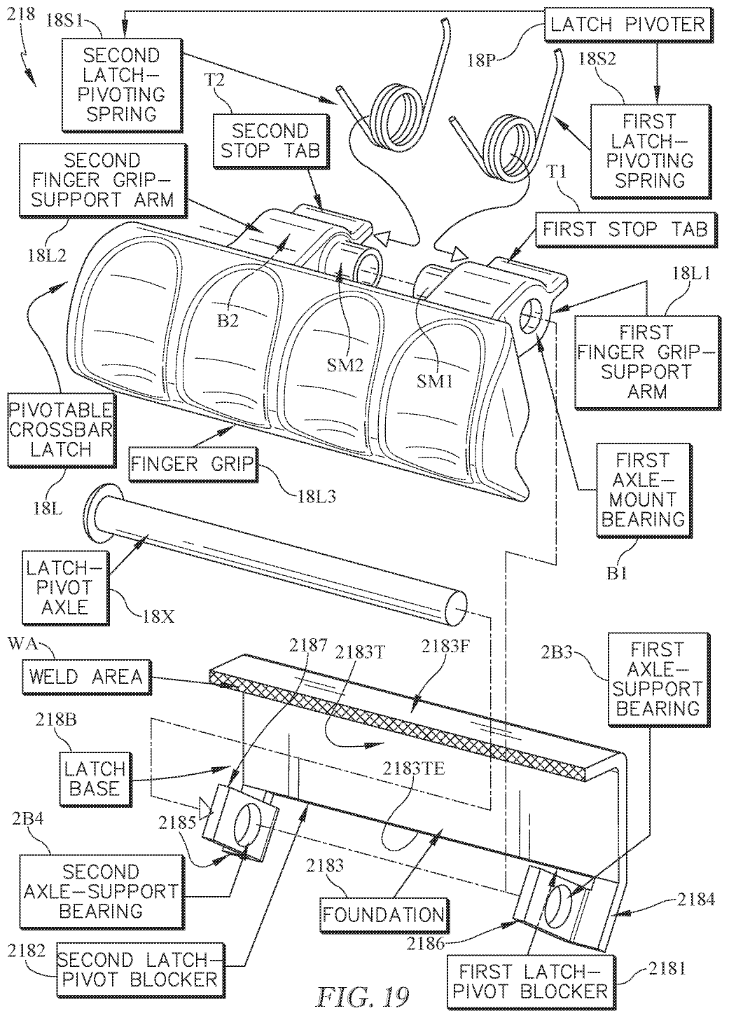

In a second embodiment in accordance with the present disclosure, a step-retainer lock 218 in a step stool 210 includes a latch base 218B is made of metal and a latch mount 218M comprising weldment (W) for welding latch base 218B to metal top step 16 as suggested in FIG. 17. Metal latch base 218B includes first and second latch-pivot blockers 2181, 2182, foundation 2183, first and second axle-support bearings 2B3, 2B4, and weld area (WA) on foundation 2183, as shown in FIG. 19. First and second latch-pivot blockers 2181, 2182 ensure pivotable crossbar latch 18L does not over rotate in a clockwise direction about latch-pivot axis 18A, as suggested by FIG. 18A1. First and second axle-support bearings 2B1, 2B2 couple latch base 218B to pivotable crossbar latch 18L. Weld area (WA) is where foundation 2183 of latch base 218B is welded using weldment (W) of latch mount 218M to an underside of metal top step 16, as shown in FIGS. 18A1, 18B1, and 19. Foundation 2183 includes a front wall 2183F and a top wall 2183T that is relatively larger than front wall 2183F.

Latch base 218B also includes angled first and second rear segments 2184, 2185 that are cantilevered to top wall 2183T as shown in FIG. 19. Front wall 2183F is perpendicular to top wall 2183T and arranged to mate with front wall 16FW of rim 16R of metal top step 16 as shown in FIG. 18A1. Top wall 2183T is arranged to mate with step panel 16P of metal top step 16 as also shown in FIG. 18A1 and to interconnect front wall 16FW of foundation 2183 and first and second rear segments 2184, 2185 as shown in FIG. 19. Rear segments 2184, 2185 lie in coplanar relation to one another and are angled relative to top wall 2183T of foundation 2183 to establish an obtuse dihedral angle between top wall 2183T of foundation 2183 and each of the rear segments 2184, 2185 shown in FIG. 19.

An upstanding first tab 2186 is also included in latch base 218B and is coupled at a right angle to an inner edge of first rear segment 2184 as shown in FIG. 19 and formed to include first axle-support bearing 2B3. An upstanding second tab 2187 is coupled at a right angle to an inner edge of second rear segment 2185 as shown in FIG. 19 and formed to include second axle-support bearing 2B4. Tabs 2186 and 2187 are arranged to lie in spaced-apart parallel relation to one another as shown in FIG. 19. A distal edge 2183TE of top wall 2183T is arranged to lie in spaced-apart relation to front wall 2183F as shown in FIG. 19 and to provide first latch-pivot blocker 2181 near first rear segment 2184 and between first and second rear segments 2184, 2185, and also to provide second latch-pivot blocker 2182 near second rear segment 2185 and between first and second rear segments 2184, 2185, as shown in FIG. 19.

First and second latch-pivot blockers 2181, 2182 of latch base 218B engage the rearwardly extending first and second stop tabs T1, T2 of first and second finger grip-support arms 18L1, 18L2 when frame 12 of step stool 210 is in the COLLAPSED-STORAGE mode, as shown in FIG. 18A1. The engagement ensures that pivotable crossbar latch 18L does not over rotate in a clockwise direction about latch-pivot axis 18A so that it assumes the NORMAL READY position shown in FIGS. 17, 18A, and 18A1. When frame 12 of step stool 210 is in the EXPANDED-USE mode, first and second latch-pivot blockers 2181, 2182 of latch base 218B are separated from first and second stop tabs T1, T2 of pivotable crossbar latch 218, as shown in FIG. 18B1. In the EXPANDED-USE mode, pivotable crossbar latch 18L engages step-support crossbar 123 to cause first and second latch-pivot blockers 2181, 2182 to be spaced apart from first and second stop tabs T1, T2.

Foundation 2183 of latch base 218B is made of metal in the second embodiment and is not formed to include any fastener-receiver holes, as shown in FIG. 19. First and second axle-support bearings 2B3, 2B4 are formed in tabs 2186, 2187 that are cantilevered to companion finger grip-support arms 18L1, 18L2 and extend away from top wall 2183T of foundation 2183 of latch base 218B, as shown in FIG. 19. First and second axle-support bearings 2B3, 2B4 allow latch-pivot axle 18X to pass through to cause latch-pivot axle 18X to connect first and second axle-support bearings 2B3, 2B4 of latch base 218B to first and second axle-mount bearings 2B1, 2B2 of pivotable crossbar latch 18L, as suggested in FIG. 19.

Weld area (WA) is provided on a distal edge of front wall 2183F of foundation 2183 of latch base 218B and allows latch base 218B to be coupled using weldment (W) of latch mount 218M to a rim front wall 16FW of rim 16R of metal top step 16, as shown in FIG. 18A1. Welding on rim front wall 16FW ensures that no fastener-receiver holes or other blemishes are visible on topside 16T of metal top step 16.

Latch-pivot axle 18X couples latch base 218B to pivotable crossbar latch 18L at latch-pivot axis 18A. Latch-pivot axle 18X connects first and second axle-mount bearings B1, B2 of pivotable crossbar latch 18L to first and second axle-support bearings 2B3, 2B4 of latch base 218B.

Latch base 218B of the releasable step-retainer lock 218 is made of metal and is welded using weldment (W) of latch mount 218M to a front rim wall 16FW of top step 16 as shown in FIG. 18A1. This allows step-release latch 218 to be coupled to metal top step 16 without forming any fastener-receiver holes or other blemishes in the topside 16T of metal top step 16 in accordance with the present disclosure.

Frame 12 of step stool 210 is in the COLLAPSED-STORAGE mode as suggested in FIG. 8A to show the pivotable crossbar latch 18L has been coupled to latch base 218B at a latch-pivot axis 18A using a latch-pivot axle 18X and moved to assume a NORMAL READY position by a latch pivoter 18P in response to a counterclockwise torque applied by latch pivoter 18P about the latch-pivot axis 18A. Latch base 218B made of metal and formed without an anchor-receiver channel 183C to be welded directly to a rim front wall 16FW of metal to step 16 using weldment (W) of latch mount 218M as shown in FIG. 18A1.

Frame 12 of step stool 210 is in the EXPANDED-USE mode as shown in FIG. 18B. The pivotable crossbar latch 18L is placed in a TEMPORARY RETRACTED position resulting from the pivotable crossbar latch 18L pivoting about the latch-pivot axis 18A in opposition to a counterclockwise torque applied by the latch pivoters 18P.

A sectional view taken along line 18A1-18A1 of FIG. 18A is provided to show engagement of a second stop tab T2 included in the pivotable crossbar latch 18L with a companion second latch-pivot blocker 2182 of included in the metal latch base 218B when frame 12 of step stool 12 is in the COLLAPSED-STORAGE mode. This ensures that the pivotable crossbar latch 218L does not over rotate in a counterclockwise direction about latch-pivot axis 18A when frame 12 is in the COLLAPSED-STORAGE mode. A sectional view taken along line 18B2-18B2 of FIG. 18B is provided in FIG. 18B2 to show the separation of second stop tab T2 of the pivotable crossbar latch 218L from the second latch-pivot blocker 2182 of latch base 218B in response to clockwise rotation of the pivotable crossbar latch 18L about latch-pivot axis 18A in opposition to a counterclockwise torque applied by latch pivoter 18P.

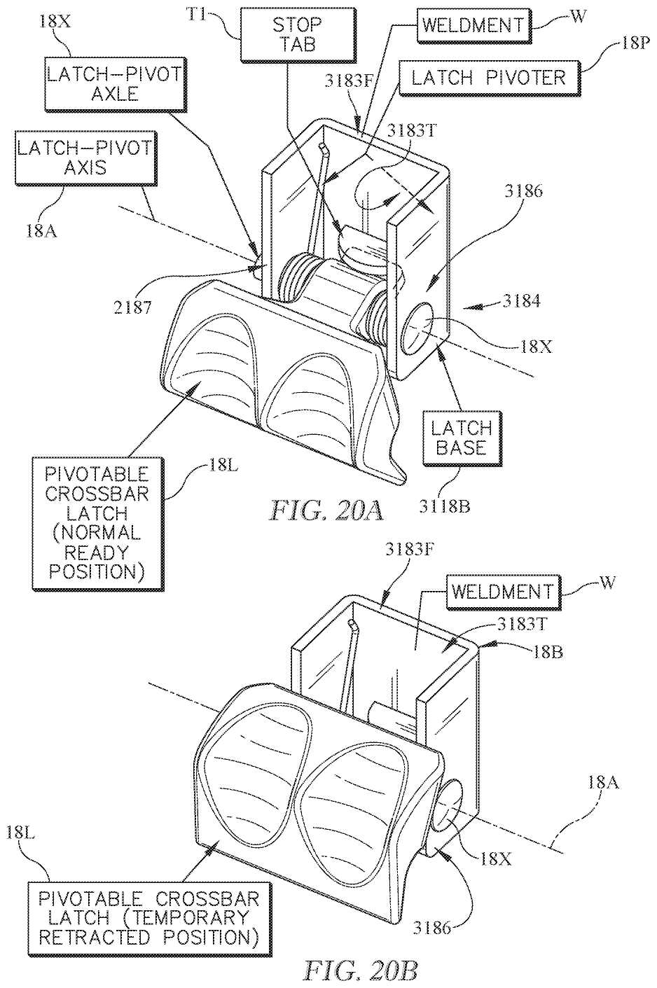

FIG. 20A is a perspective view of an alternative releasable step-retainer lock showing that a pivotable crossbar latch 18L is mounted on a latch-pivot axle 18X that is coupled to a latch base 3118B. The latch base 3118B forms a C-channel with a rear segment 3184 supporting side tabs 3186. Stop tab T1 is arranged to extend from a front 3183F of rear segment 3184; and stop tab T1 extends into an anchor receiver channel 3183T between the side tabs 3186.

1. A foldable step stool comprising
an expandable step frame including a front leg unit and a rear leg unit pivotably coupled to the front leg unit at a leg-pivot axis for pivotable movement relative to the front leg unit during a change in the expandable step frame from a collapsed-storage mode in which the rear leg unit lies alongside the front leg unit to an expanded use mode in which ground-engaging lower ends of the rear leg unit and the front leg unit are separated to establish an acute angle between the front and rear leg units, the rear leg unit including first and second rear legs and a step-support crossbar arranged to interconnect the first and second rear legs,
a metal top step including a step panel on which a user may stand when the step frame is in in the expanded-use mode and a rim coupled to a perimeter of the step panel, the metal top step being pivotably coupled to each of the front and the rear legs units to support the step panel for movement between a horizontal orientation when the expandable step frame is in the expanded-use mode and a vertical orientation when the expandable step frame is in the collapsed-storage mode, and
a releasable step-retainer lock including a latch base, a pivotable crossbar latch supported for pivotable movement about a latch-pivot axis relative to the latch base to engage the step-support crossbar of the step frame when the step frame is in the expanded-use mode to stabilize the expandable step frame and the step stool is opened and to disengage the step-support crossbar of the step frame when the step frame is in the collapsed-storage mode and the step stool is closed, and latch-mount means for coupling the latch base to an underside of the metal top step to cause the releasable step-retainer lock to move with the metal top step relative to the step frame during a change of the step frame between the collapsed-storage mode and the expanded-use mode without forming holes or other blemishes in the step panel of the metal top step.

2. The foldable step stool of claim 1, wherein the latch base is made of a plastics material and the latch-mount means includes a latch-base anchor made of a metal material and arranged to engage on underside of the step panel of the top metal step and weldment coupled to the latch-base anchor and to the rim of the metal top step.

3. The foldable step stool of claim 2, wherein the latch-base anchor is an elongated metal anchor strip having a first end and an opposite second end and the latch-mount means includes a first weldment arranged to couple the first end of the elongated metal anchor strip to the first rim side wall of the rim and a second weldment arranged to couple the second end of the elongated metal anchor strip to an opposing second rim side wall of the rim.

4. The foldable step stool of claim 1, wherein the rim includes a first rim side wall, an opposing second rim side wall arranged to lie in spaced-apart relation to the first rim side wall, and a rim front wall arranged to interconnect end portions of each of the first and second rim side walls, the latch base is made of a metal material, and the latch-mount means comprises weldment that is arranged to couple the latch base to the rim front wall of the rim.

5. The foldable step stool of claim 4, wherein the latch base includes a foundation arranged to engage the underside of the metal top step, the foundation includes a top wall arranged to engage the underside of the step panel of the top metal step and a front wall arranged to lie in perpendicular relation to the top wall and to engage the rim front wall of the rim, and the weldment is coupled to each of the front wall of the foundation and the rim front wall of the rim to hold the latch base in a stationary positon on the underside of the metal top step.
